(19) United States
(12) Patent Application Publication
(10) Pub. No.: US 2025/0245966 A1
(43) Pub. Date: Jul. 31, 2025

(54) SELF-KNOWLEDGE DISTILLATION FOR SURGICAL PHASE RECOGNITION

(71) Applicant: DIGITAL SURGERY LIMITED, London (GB)

(72) Inventors: Jinglu Zhang, London (GB); Abdolrahim Kadkhodamohammadi, London (GB); Imanol Luengo Muntion, Bilbao (ES); Danail V. Stoyanov, London (GB); Santiago Barbarisi, London (GB)

(21) Appl. No.: 18/848,278

(22) PCT Filed: Apr. 14, 2023
(86) PCT No.: PCT/EP2023/059762

§ 371 Date: Sep. 18, 2024

Related U.S. Application Data
(60) Provisional application No. 63/330,942, filed on Apr. 14, 2022.
(60) Provisional application No. 63/424,278, filed on Nov. 10, 2022.
(60) Provisional application No. 63/495,607, filed on Apr. 12, 2023.

(51) Int. Cl. G06V 10/764; G06V 10/62; G06V 10/766; G06V 10/77; G06V 10/776; G06V 10/778; G06V 10/82; G06V 10/96; G06V 20/40

(52) U.S. Cl. CPC G06V 10/764; G06V 10/62; G06V 10/766; G06V 10/7715; G06V 10/776; G06V 10/7792; G06V 10/82; G06V 10/96; G06V 20/41; G06V 20/46; G06V 2201/034

(57) ABSTRACT

Examples described herein provide a computer-implemented method that includes performing training of a self-knowledge distillation encoder and a self-knowledge distillation decoder for video frames of a surgical procedure. A trained version of the self-knowledge distillation encoder and the self-knowledge distillation decoder can be combined as a phase recognition model to predict surgical phases of the surgical procedure in one or more videos.

### BACKGROUND

The present disclosure relates in general to computing technology and relates more particularly to computing technology for a surgical phase recognition.

Computer-assisted systems, particularly computer-assisted surgery systems (CASs), rely on video data digitally captured during a surgery. Such video data can be stored and/or streamed. In some cases, the video data can be used to augment a person's physical sensing, perception, and reaction capabilities. For example, such systems can effectively provide the information corresponding to an expanded field of vision, both temporal and spatial, that enables a person to adjust current and future actions based on the part of an environment not included in his or her physical field of view. Alternatively, or in addition, the video data can be stored and/or transmitted for several purposes, such as archival, training, post-surgery analysis, and/or patient consultation.

Automating a process of classifying content appearing within a surgical video can be challenging. Misclassification can occur depending in part upon how a model is trained to perform classification.

### SUMMARY

According to an aspect, a computer-implemented method is provided. The method includes performing training of a self-knowledge distillation encoder using a plurality of video frames of a surgical procedure by joint optimization of a classification loss and feature similarity loss through a student encoder network and a teacher encoder network. The method also includes providing a plurality of features extracted by the student encoder network to a self-knowledge distillation decoder. The method further includes performing training of the self-knowledge distillation decoder using the features, where the self-knowledge distillation decoder comprises a student decoder network and a teacher decoder network, and a plurality of soft labels generated by the teacher decoder network are used to regularize a prediction of the student decoder network. The method additionally includes combining a trained version of the self-knowledge distillation encoder and the self-knowledge distillation decoder as a phase recognition model to predict surgical phases of the surgical procedure in one or more videos.

According to another aspect, a system includes a data store and a machine learning training system. The data store includes video data associated with a surgical procedure. The machine learning training system is configured to train a self-knowledge distillation encoder using a plurality of video frames of the video data by joint optimization of a classification loss and feature similarity loss through a student encoder network and a teacher encoder network and train a self-knowledge distillation decoder using a plurality of features extracted by the student encoder network. The self-knowledge distillation decoder includes a student decoder network and a teacher decoder network. A trained version of the self-knowledge distillation encoder and the self-knowledge distillation decoder are stored as a phase recognition model.

According to an aspect, a computer-implemented method is provided. The method includes performing spatial feature extraction from a video of a surgical procedure to extract a plurality of features representing the video and providing the features to a boundary regression branch to predict one or more action boundaries of the video. The method also includes providing the features to a frame-wise phase classification branch to predict one or more frame-wise phase classifications and performing an aggregation of an output of the boundary regression branch with an output of the frame-wise phase classification branch to predict a surgical phase of the surgical procedure depicted in the video.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the aspects of the disclosure are apparent from the following detailed description taken in conjunction with the accompanying drawings in which:

FIG. 1 depicts a computer-assisted surgery (CAS) system according to one or more aspects;

FIG. 2 depicts a surgical procedure system according to one or more aspects;

FIG. 3 depicts a system for analyzing video and data according to one or more aspects;

FIG. 4 depicts a block diagram of a self-knowledge distillation system according to one or more aspects;

FIG. 5A depicts a scatter plot of video frame features according to one approach.

FIG. 5B depicts a scatter plot of video frame features according to one or more aspects;

FIG. 6 depicts a plot of prediction results according to one or more aspects;

FIG. 7 depicts a flowchart of a method of self-knowledge distillation for surgical phase recognition according to one or more aspects;

FIG. 8 depicts a block diagram of a computer system according to one or more aspects;

FIG. 9 depicts a block diagram of a boundary aware hybrid embedding network according to one or more aspects; and

FIG. 10 depicts a flowchart of a method of surgical phase recognition using a boundary aware hybrid embedding network according to one or more aspects.

The diagrams depicted herein are illustrative. There can be many variations to the diagrams and/or the operations described herein without departing from the spirit of the described aspects. For instance, the actions can be performed in a differing order, or actions can be added, deleted, or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Exemplary aspects of the technical solutions described herein include systems and methods for self-knowledge distillation for surgical phase recognition and a boundary aware hybrid embedding network for surgical phase recognition.

Surgical workflow analysis, also called surgical phase recognition, addresses the technical challenge of segmenting surgical videos into corresponding pre-defined phases. It has been a fundamental task for a context-aware surgical assistance system as it contributes to resource scheduling, surgery monitoring, decision support, etc. However, classifying surgical frames is technically challenging due to at least the following reasons:
1.) Surgical videos are long and untrimmed, making capturing the temporal dependencies difficult.
2.) Boundary frames are regarded as ambiguous frames because there are sudden label changes during the continuous frame transition.
3.) Surgical video labels often suffer from the data imbalance problem, i.e., some phases have a larger sample size than other phases with fewer samples.

To address these challenges, technical solutions described herein provide self-knowledge distillation and/or a boundary aware hybrid embedding network for accurate surgical phase recognition. Self-knowledge distillation can be integrated into current state-of-the-art (SOTA) models that use an encoder-decoder framework. Further, self-knowledge distillation may be used for training either or both of an encoder and decoder of a model for recognition, such as surgical phase recognition. In some aspects, a boundary aware hybrid embedding network can use a pre-trained encoder, such as a squeeze-and-excitation network (SENet), or other such spatial feature extracting network. As one example, the pre-trained encoder can expand upon a residual learning network used as a backbone for self-knowledge distillation.

Knowledge distillation is a framework for network regularization where knowledge is distilled from a teacher network to a student network. In self-knowledge distillation, the student model becomes the teacher such that the network learns from itself. Phase recognition models can be implemented in an encoder-decoder framework. According to an aspect, self-knowledge distillation can be applied to both an encoder and decoder. The teacher model can guide the training process of the student model to extract enhanced feature representations from the encoder and build a more robust temporal decoder to reduce over-segmentation.

With the increasing effort in improving patient outcomes and enhancing human-computer interaction, more attention is now being paid to developing Context-aware surgical (CAS) systems for the operation room. Surgical phase recognition is one of the fundamental tasks in developing CAS systems, which aims at dividing a surgical procedure into segments intra-operatively with reference to its pre-defined standard steps. Applications of real-time phase recognition for surgical videos include surgery monitoring, resource scheduling, decision making support. However, this task is quite challenging due to high intra-phase and low inter-phase variance, and long duration of surgical videos.

EndoNet is an existing phase recognition model that utilizes a deep neural network (DNN) as a feature encoder, combined with a support vector machine (SVM) and hidden Markov models (HMM) to detect surgical phases. With the rise in popularity of Recurrent Neural Networks (RNNs), DNNs are used in other existing solutions, both as encoders to extract latent features and temporal decoders to replace conventional graphical models. Several state-of-the-art techniques have advanced phase recognition models by using deeper and deeper encoders, such as a residual neural network (ResNet) in temporal convolutional networks for the operating room (TeCNo), inflated 3D networks (I3D) in semantic segmentation network (SWNet), video shifted window (Swin)-transformer in gated recurrent unit (GRU), and more advanced temporal decoders, for example temporal convolutional based and transformer-based online surgical phase prediction (OperA) and phase recognition from surgical videos via hybrid embedding aggregation transformer (Trans-SVNet). However, more reliable models are required, and a technical challenge exists in determining whether the full capacity of these models are utilized and what complexity solutions should be used to address the technical challenges of surgical phase recognition.

Technical solutions are described herein to address such technical challenges. Particularly, technical solutions herein take advantage of knowledge distillation as a model-agnostic solution to improve the surgical phase recognition performance. Knowledge distillation (KD) is a process of transferring knowledge from a heavier and better performing teacher model to a smaller one. It has been shown that a model can be regularized by distilling the internal knowledge of student network itself, namely self-knowledge distillation (self-KD). The self-KD framework can be combined with various backbone models without increasing the network complexity.

Technical solutions herein provide a self-knowledge distillation framework built upon phase recognition models without adding extra trainable modules or additional annotations. The framework provided by the technical solutions herein integrates self-KD into both an encoder and decoder. At the encoder stage, encoders are trained by optimizing both frame classification and feature similarity objectives. This facilitates obtaining more robust encoders by optimizing both objectives jointly. This is in contrast with existing self-supervised approaches like a simple framework for contrastive learning of visual representations (SimCLR), momentum contrast (MoCo) or bootstrap your own latent (BYOL), that add an extra pre-training step. The motivation of this raises from the high similarity of frames across different phases in a laparoscopic videos. Rather, self-supervised approaches are applied to image datasets, where inter-class variability is high. The classification objective is optimized in the last fully connected layer in a supervised manner. While feature similarity objective is optimized at the output of the backbone. In some aspects, a target feature signal is generated by an auxiliary teacher network. Obtained representations are obtained from different augmented views of an image. This supports obtaining more reliable representations that are more robust to intra-phase variation.

Further, in aspects of the technical solutions herein, at the decoder stage, a self-KD can be used to address the common problem of over-segmentation in temporal models. For a temporal backbone model, a best model from preceding epochs can be used as the teacher model to generate soft labels. The soft labels from the teacher model can push the student model (current epoch) to have more consistent predictions for the same frame with variant logits. The model can be regularized by minimizing teacher and student logits using a smoothing loss. The self-KD strategy applied to surgical phase recognition frameworks can show consistent improvement across different frameworks.

Aspects of the technical solutions herein are rooted in computing technology, particularly artificial intelligence, and more particularly to neural network framework/architecture. Aspects of the technical solutions herein provide improvements to such computing technology. For example, aspects of the technical solutions herein embed self-KD into surgical phase recognition neural network architectures in a plug and play manner. As a result, aspects of the technical solutions herein serve as a basic building block for any phase recognition model due to its generality.

Further, with teacher-student configuration, implicit knowledge is distilled from teacher to student module. Aspects of the technical solutions herein enable the encoder to extract enhanced spatial features and reduce over-segmentation at the decoder.

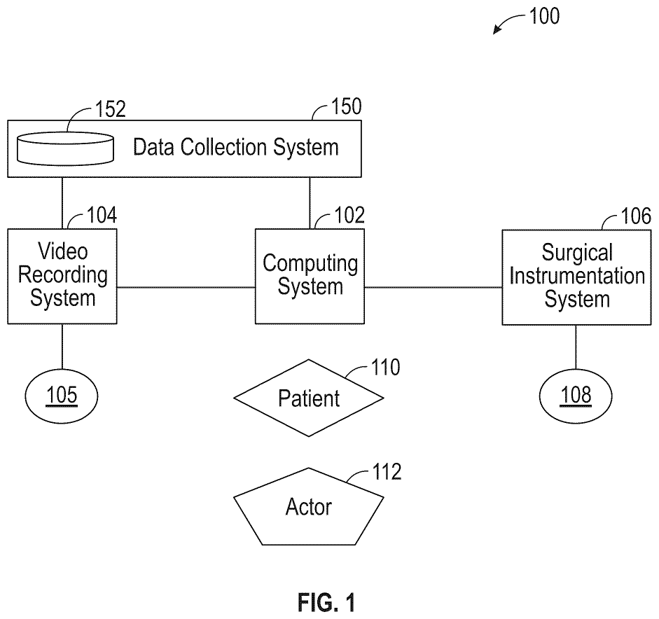

Turning now to FIG. 1, an example computer-assisted system (CAS) system 100 is generally shown in accordance with one or more aspects. The CAS system 100 includes at least a computing system 102, a video recording system 104, and a surgical instrumentation system 106. As illustrated in FIG. 1, an actor 112 can be medical personnel that uses the CAS system 100 to perform a surgical procedure on a patient 110. Medical personnel can be a surgeon, assistant, nurse, administrator, or any other actor that interacts with the CAS system 100 in a surgical environment. The surgical procedure can be any type of surgery, such as but not limited to cataract surgery, laparoscopic cholecystectomy, endoscopic endonasal transsphenoidal approach (eTSA) to resection of pituitary adenomas, or any other surgical procedure. In other examples, actor 112 can be a technician, an administrator, an engineer, or any other such personnel that interacts with the CAS system 100. For example, actor 112 can record data from the CAS system 100, configure/update one or more attributes of the CAS system 100, review past performance of the CAS system 100, repair the CAS system 100, and/or the like including combinations and/or multiples thereof.

A surgical procedure can include multiple phases, and each phase can include one or more surgical actions. A “surgical action” can include an incision, a compression, a stapling, a clipping, a suturing, a cauterization, a sealing, or any other such actions performed to complete a phase in the surgical procedure. A “phase” represents a surgical event that is composed of a series of steps (e.g., closure). A “step” refers to the completion of a named surgical objective (e.g., hemostasis). During each step, certain surgical instruments 108 (e.g., forceps) are used to achieve a specific objective by performing one or more surgical actions. In addition, a particular anatomical structure of the patient may be the target of the surgical action(s).

The video recording system 104 includes one or more cameras 105, such as operating room cameras, endoscopic cameras, and/or the like including combinations and/or multiples thereof. The cameras 105 capture video data of the surgical procedure being performed. The video recording system 104 includes one or more video capture devices that can include cameras 105 placed in the surgical room to capture events surrounding (i.e., outside) the patient being operated upon. The video recording system 104 further includes cameras 105 that are passed inside (e.g., endoscopic cameras) the patient 110 to capture endoscopic data. The endoscopic data provides video and images of the surgical procedure.

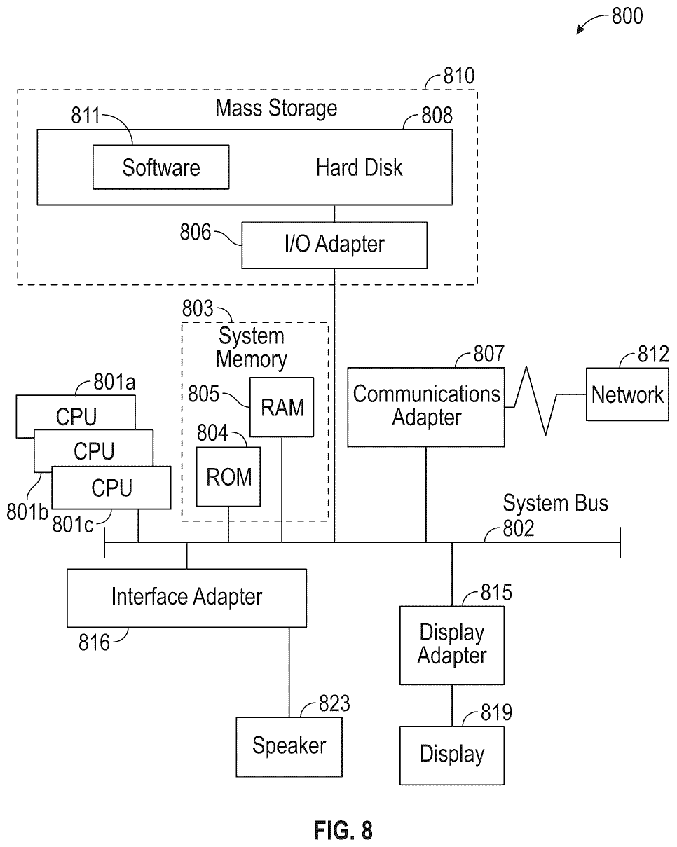

The computing system 102 includes one or more memory devices, one or more processors, a user interface device, among other components. All or a portion of the computing system 102 shown in FIG. 1 can be implemented for example, by all or a portion of computer system 800 of FIG. 8. Computing system 102 can execute one or more computer-executable instructions. The execution of the instructions facilitates the computing system 102 to perform one or more methods, including those described herein. The computing system 102 can communicate with other computing systems via a wired and/or a wireless network. In one or more examples, the computing system 102 includes one or more trained machine learning models that can detect and/or predict features of/from the surgical procedure that is being performed or has been performed earlier. Features can include structures, such as anatomical structures, surgical instruments 108 in the captured video of the surgical procedure. Features can further include events, such as phases and/or actions in the surgical procedure. Features that are detected can further include the actor 112 and/or patient 110. Based on the detection, the computing system 102, in one or more examples, can provide recommendations for subsequent actions to be taken by the actor 112. Alternatively, or in addition, the computing system 102 can provide one or more reports based on the detections. The detections by the machine learning models can be performed in an autonomous or semi-autonomous manner.

The machine learning models can include artificial neural networks, such as deep neural networks, convolutional neural networks, recurrent neural networks, vision transformers, encoders, decoders, or any other type of machine learning model. The machine learning models can be trained in a supervised, unsupervised, or hybrid manner. The machine learning models can be trained to perform detection and/or prediction using one or more types of data acquired by the CAS system 100. For example, the machine learning models can use the video data captured via the video recording system 104. Alternatively, or in addition, the machine learning models use the surgical instrumentation data from the surgical instrumentation system 106. In yet other examples, the machine learning models use a combination of video data and surgical instrumentation data.

Additionally, in some examples, the machine learning models can also use audio data captured during the surgical procedure. The audio data can include sounds emitted by the surgical instrumentation system 106 while activating one or more surgical instruments 108. Alternatively, or in addition, the audio data can include voice commands, snippets, or dialog from one or more actors 112. The audio data can further include sounds made by the surgical instruments 108 during their use.

In one or more examples, the machine learning models can detect surgical actions, surgical phases, anatomical structures, surgical instruments, and various other features from the data associated with a surgical procedure. The detection can be performed in real-time in some examples. Alternatively, or in addition, the computing system 102 analyzes the surgical data, i.e., the various types of data captured during the surgical procedure, in an offline manner (e.g., post-surgery). In one or more examples, the machine learning models detect surgical phases based on detecting some of the features, such as the anatomical structure, surgical instruments, and/or the like including combinations and/or multiples thereof.

A data collection system 150 can be employed to store the surgical data, including the video(s) captured during the surgical procedures. The data collection system 150 includes one or more storage devices 152. The data collection system 150 can be a local storage system, a cloud-based storage system, or a combination thereof. Further, the data collection system 150 can use any type of cloud-based storage architecture, for example, public cloud, private cloud, hybrid cloud, and/or the like including combinations and/or multiples thereof. In some examples, the data collection system can use a distributed storage, i.e., the storage devices 152 are located at different geographic locations. The storage devices 152 can include any type of electronic data storage media used for recording machine-readable data, such as semiconductor-based, magnetic-based, optical-based storage media, and/or the like including combinations and/or multiples thereof. For example, the data storage media can include flash-based solid-state drives (SSDs), magnetic-based hard disk drives, magnetic tape, optical discs, and/or the like including combinations and/or multiples thereof.

In one or more examples, the data collection system 150 can be part of the video recording system 104, or vice-versa. In some examples, the data collection system 150, the video recording system 104, and the computing system 102, can communicate with each other via a communication network, which can be wired, wireless, or a combination thereof. The communication between the systems can include the transfer of data (e.g., video data, instrumentation data, and/or the like including combinations and/or multiples thereof), data manipulation commands (e.g., browse, copy, paste, move, delete, create, compress, and/or the like including combinations and/or multiples thereof), data manipulation results, and/or the like including combinations and/or multiples thereof. In one or more examples, the computing system 102 can manipulate the data already stored/being stored in the data collection system 150 based on outputs from the one or more machine learning models (e.g., phase detection, anatomical structure detection, surgical tool detection, and/or the like including combinations and/or multiples thereof). Alternatively, or in addition, the computing system 102 can manipulate the data already stored/being stored in the data collection system 150 based on information from the surgical instrumentation system 106.

In one or more examples, the video captured by the video recording system 104 is stored on the data collection system 150. In some examples, the computing system 102 curates parts of the video data being stored on the data collection system 150. In some examples, the computing system 102 filters the video captured by the video recording system 104 before it is stored on the data collection system 150. Alternatively, or in addition, the computing system 102 filters the video captured by the video recording system 104 after it is stored on the data collection system 150.

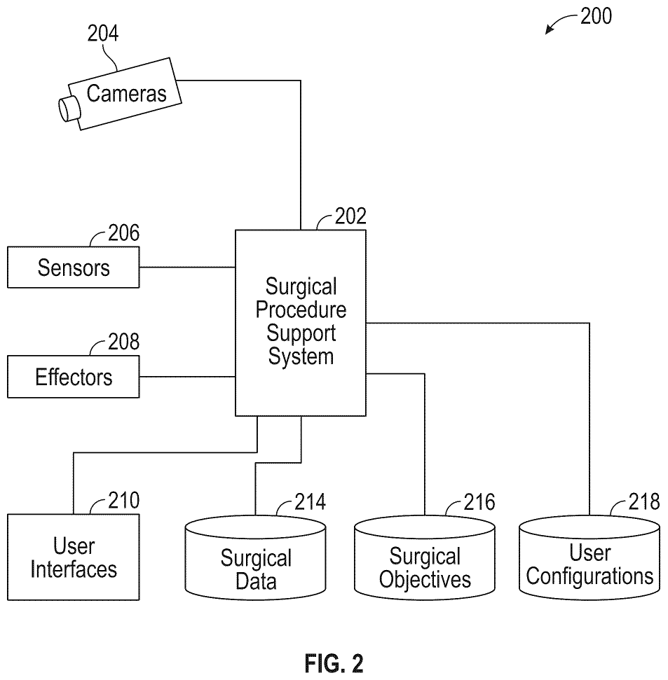

Turning now to FIG. 2, a surgical procedure system 200 is generally shown according to one or more aspects. The example of FIG. 2 depicts a surgical procedure support system 202 that can include or may be coupled to the CAS system 100 of FIG. 1. The surgical procedure support system 202 can acquire image or video data using one or more cameras 204. The surgical procedure support system 202 can also interface with one or more sensors 206 and/or one or more effectors 208. The sensors 206 may be associated with surgical support equipment and/or patient monitoring. The effectors 208 can be robotic components or other equipment controllable through the surgical procedure support system 202. The surgical procedure support system 202 can also interact with one or more user interfaces 210, such as various input and/or output devices. The surgical procedure support system 202 can store, access, and/or update surgical data 214 associated with a training dataset and/or live data as a surgical procedure is being performed on patient 110 of FIG. 1. The surgical procedure support system 202 can store, access, and/or update surgical objectives 216 to assist in training and guidance for one or more surgical procedures. User configurations 218 can track and store user preferences.

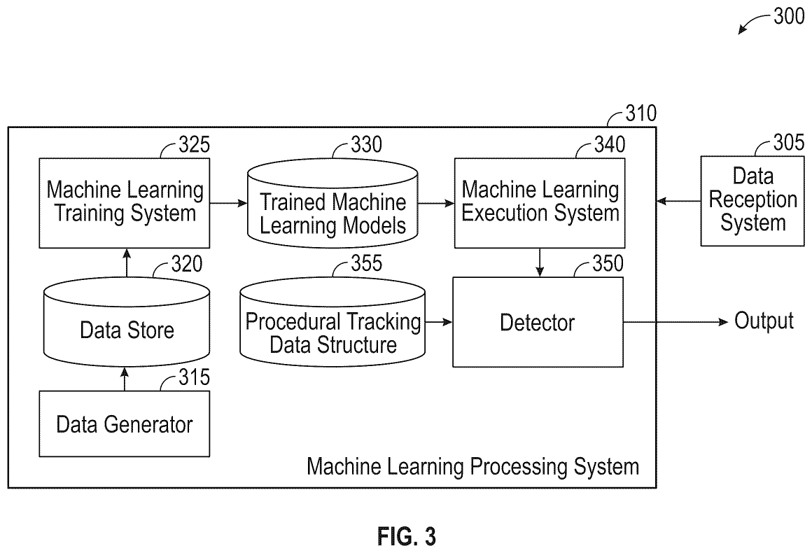

Turning now to FIG. 3, a system 300 for analyzing video and data is generally shown according to one or more aspects. In accordance with aspects, the video and data is captured from video recording system 104 of FIG. 1. The analysis can result in predicting features that include surgical phases and structures (e.g., instruments, anatomical structures, and/or the like including combinations and/or multiples thereof) in the video data using machine learning. System 300 can be the computing system 102 of FIG. 1, or a part thereof in one or more examples. System 300 uses data streams in the surgical data to identify procedural states according to some aspects.

System 300 includes a data reception system 305 that collects surgical data, including the video data and surgical instrumentation data. The data reception system 305 can include one or more devices (e.g., one or more user devices and/or servers) located within and/or associated with a surgical operating room and/or control center. The data reception system 305 can receive surgical data in real-time, i.e., as the surgical procedure is being performed. Alternatively, or in addition, the data reception system 305 can receive or access surgical data in an offline manner, for example, by accessing data that is stored in the data collection system 150 of FIG. 1.

System 300 further includes a machine learning processing system 310 that processes the surgical data using one or more machine learning models to identify one or more features, such as surgical phase, instrument, anatomical structure, and/or the like including combinations and/or multiples thereof, in the surgical data. It will be appreciated that machine learning processing system 310 can include one or more devices (e.g., one or more servers), each of which can be configured to include part or all of one or more of the depicted components of the machine learning processing system 310. In some instances, a part or all of the machine learning processing system 310 is cloud-based and/or remote from an operating room and/or physical location corresponding to a part or all of data reception system 305. It will be appreciated that several components of the machine learning processing system 310 are depicted and described herein. However, the components are just one example structure of the machine learning processing system 310, and that in other examples, the machine learning processing system 310 can be structured using a different combination of the components. Such variations in the combination of the components are encompassed by the technical solutions described herein.

The machine learning processing system 310 includes a machine learning training system 325, which can be a separate device (e.g., server) that stores its output as one or more trained machine learning models 330. The machine learning models 330 are accessible by a machine learning execution system 340. The machine learning execution system 340 can be separate from the machine learning training system 325 in some examples. In other words, in some aspects, devices that “train” the models are separate from devices that “infer,” i.e., perform real-time processing of surgical data using the trained machine learning models 330.

Machine learning processing system 310, in some examples, further includes a data generator 315 to generate simulated surgical data, such as a set of synthetic images and/or synthetic video, in combination with real image and video data from the video recording system 104, to generate trained machine learning models 330. Data generator 315 can access (read/write) a data store 320 to record data, including multiple images and/or multiple videos. The images and/or videos can include images and/or videos collected during one or more procedures (e.g., one or more surgical procedures). For example, the images and/or video may have been collected by a user device worn by the actor 112 of FIG. 1 (e.g., surgeon, surgical nurse, anesthesiologist, and/or the like including combinations and/or multiples thereof) during the surgery, a non-wearable imaging device located within an operating room, an endoscopic camera inserted inside the patient 110 of FIG. 1, and/or the like including combinations and/or multiples thereof. The data store 320 is separate from the data collection system 150 of FIG. 1 in some examples. In other examples, the data store 320 is part of the data collection system 150.

Each of the images and/or videos recorded in the data store 320 for performing training (e.g., generating the machine learning models 330) can be defined as a base image and can be associated with other data that characterizes an associated procedure and/or rendering specifications. For example, the other data can identify a type of procedure, a location of a procedure, one or more people involved in performing the procedure, surgical objectives, and/or an outcome of the procedure. Alternatively, or in addition, the other data can indicate a stage of the procedure with which the image or video corresponds, rendering specification with which the image or video corresponds and/or a type of imaging device that captured the image or video (e.g., and/or, if the device is a wearable device, a role of a particular person wearing the device, and/or the like including combinations and/or multiples thereof). Further, the other data can include image-segmentation data that identifies and/or characterizes one or more objects (e.g., tools, anatomical objects, and/or the like including combinations and/or multiples thereof) that are depicted in the image or video. The characterization can indicate the position, orientation, or pose of the object in the image. For example, the characterization can indicate a set of pixels that correspond to the object and/or a state of the object resulting from a past or current user handling. Localization can be performed using a variety of techniques for identifying objects in one or more coordinate systems.

The machine learning training system 325 uses the recorded data in the data store 320, which can include the simulated surgical data (e.g., set of synthetic images and/or synthetic video) and/or actual surgical data to generate the trained machine learning models 330. The trained machine learning models 330 can be defined based on a type of model and a set of hyperparameters (e.g., defined based on input from a client device). The trained machine learning models 330 can be configured based on a set of parameters that can be dynamically defined based on (e.g., continuous or repeated) training (i.e., learning, parameter tuning). Machine learning training system 325 can use one or more optimization algorithms to define the set of parameters to minimize or maximize one or more loss functions. The set of (learned) parameters can be stored as part of the trained machine learning models 330 using a specific data structure for a particular trained machine learning model of the trained machine learning models 330. The data structure can also include one or more non-learnable variables (e.g., hyperparameters and/or model definitions).

Machine learning execution system 340 can access the data structure(s) of the trained machine learning models 330 and accordingly configure the trained machine learning models 330 for inference (e.g., prediction, classification, and/or the like including combinations and/or multiples thereof). The trained machine learning models 330 can include, for example, a fully convolutional network adaptation, an adversarial network model, an encoder, a decoder, or other types of machine learning models. The type of the trained machine learning models 330 can be indicated in the corresponding data structures. The trained machine learning models 330 can be configured in accordance with one or more hyperparameters and the set of learned parameters.

The trained machine learning models 330, during execution, receive, as input, surgical data to be processed and subsequently generate one or more inferences according to the training. For example, the video data captured by the video recording system 104 of FIG. 1 can include data streams (e.g., an array of intensity, depth, and/or RGB values) for a single image or for each of a set of frames (e.g., including multiple images or an image with sequencing data) representing a temporal window of fixed or variable length in a video. The video data that is captured by the video recording system 104 can be received by the data reception system 305, which can include one or more devices located within an operating room where the surgical procedure is being performed. Alternatively, the data reception system 305 can include devices that are located remotely, to which the captured video data is streamed live during the performance of the surgical procedure. Alternatively, or in addition, the data reception system 305 accesses the data in an offline manner from the data collection system 150 or from any other data source (e.g., local or remote storage device).

The data reception system 305 can process the video and/or data received. The processing can include decoding when a video stream is received in an encoded format such that data for a sequence of images can be extracted and processed. The data reception system 305 can also process other types of data included in the input surgical data. For example, the surgical data can include additional data streams, such as audio data, RFID data, textual data, measurements from one or more surgical instruments/sensors, and/or the like including combinations and/or multiples thereof, that can represent stimuli/procedural states from the operating room. The data reception system 305 synchronizes the different inputs from the different devices/sensors before inputting them in the machine learning processing system 310.

The trained machine learning models 330, once trained, can analyze the input surgical data, and in one or more aspects, predict and/or characterize features (e.g., structures) included in the video data included with the surgical data. The video data can include sequential images and/or encoded video data (e.g., using digital video file/stream formats and/or codecs, such as MP4, MOV, AVI, WEBM, AVCHD, OGG, and/or the like including combinations and/or multiples thereof). The prediction and/or characterization of the features can include segmenting the video data or predicting the localization of the structures with a probabilistic heatmap. In some instances, the one or more trained machine learning models 330 include or are associated with a preprocessing or augmentation (e.g., intensity normalization, resizing, cropping, and/or the like including combinations and/or multiples thereof) that is performed prior to segmenting the video data. An output of the one or more trained machine learning models 330 can include image-segmentation or probabilistic heatmap data that indicates which (if any) of a defined set of structures are predicted within the video data, a location and/or position and/or pose of the structure(s) within the video data, and/or state of the structure(s). The location can be a set of coordinates in an image/frame in the video data. For example, the coordinates can provide a bounding box. The coordinates can provide boundaries that surround the structure(s) being predicted. The trained machine learning models 330, in one or more examples, are trained to perform higher-level predictions and tracking, such as predicting a phase of a surgical procedure and tracking one or more surgical instruments used in the surgical procedure.

While some techniques for predicting a surgical phase (“phase”) in the surgical procedure are described herein, it should be understood that any other technique for phase prediction can be used without affecting the aspects of the technical solutions described herein. In some examples, the machine learning processing system 310 includes a detector 350 that uses the trained machine learning models 330 to identify various items or states within the surgical procedure (“procedure”). The detector 350 can use a particular procedural tracking data structure 355 from a list of procedural tracking data structures. The detector 350 can select the procedural tracking data structure 355 based on the type of surgical procedure that is being performed. In one or more examples, the type of surgical procedure can be predetermined or input by actor 112. For instance, the procedural tracking data structure 355 can identify a set of potential phases that can correspond to a part of the specific type of procedure as “phase predictions”, where the detector 350 is a phase detector.

In some examples, the procedural tracking data structure 355 can be a graph that includes a set of nodes and a set of edges, with each node corresponding to a potential phase. The edges can provide directional connections between nodes that indicate (via the direction) an expected order during which the phases will be encountered throughout an iteration of the procedure. The procedural tracking data structure 355 may include one or more branching nodes that feed to multiple next nodes and/or can include one or more points of divergence and/or convergence between the nodes. In some instances, a phase indicates a procedural action (e.g., surgical action) that is being performed or has been performed and/or indicates a combination of actions that have been performed. In some instances, a phase relates to a biological state of a patient undergoing a surgical procedure. For example, the biological state can indicate a complication (e.g., blood clots, clogged arteries/veins, and/or the like including combinations and/or multiples thereof), pre-condition (e.g., lesions, polyps, and/or the like including combinations and/or multiples thereof). In some examples, the trained machine learning models 330 are trained to detect an “abnormal condition,” such as hemorrhaging, arrhythmias, blood vessel abnormality, and/or the like including combinations and/or multiples thereof.

Each node within the procedural tracking data structure 355 can identify one or more characteristics of the phase corresponding to that node. The characteristics can include visual characteristics. In some instances, the node identifies one or more tools that are typically in use or available for use (e.g., on a tool tray) during the phase. The node also identifies one or more roles of people who are typically performing a surgical task, a typical type of movement (e.g., of a hand or tool), and/or the like including combinations and/or multiples thereof. Thus, detector 350 can use the segmented data generated by machine learning execution system 340 that indicates the presence and/or characteristics of particular objects within a field of view to identify an estimated node to which the real image data corresponds. Identification of the node (i.e., phase) can further be based upon previously detected phases for a given procedural iteration and/or other detected input (e.g., verbal audio data that includes person-to-person requests or comments, explicit identifications of a current or past phase, information requests, and/or the like including combinations and/or multiples thereof).

The detector 350 can output predictions, such as a phase prediction associated with a portion of the video data that is analyzed by the machine learning processing system 310. The phase prediction is associated with the portion of the video data by identifying a start time and an end time of the portion of the video that is analyzed by the machine learning execution system 340. The phase prediction that is output can include segments of the video where each segment corresponds to and includes an identity of a surgical phase as detected by the detector 350 based on the output of the machine learning execution system 340. Further, the phase prediction, in one or more examples, can include additional data dimensions, such as, but not limited to, identities of the structures (e.g., instrument, anatomy, and/or the like including combinations and/or multiples thereof) that are identified by the machine learning execution system 340 in the portion of the video that is analyzed. The phase prediction can also include a confidence score of the prediction. Other examples can include various other types of information in the phase prediction that is output. Further, other types of outputs of the detector 350 can include state information or other information used to generate audio output, visual output, and/or commands. For instance, the output can trigger an alert, an augmented visualization, identify a predicted current condition, identify a predicted future condition, command control of equipment, and/or result in other such data/commands being transmitted to a support system component, e.g., through surgical procedure support system 202 of FIG. 2.

It should be noted that although some of the drawings depict endoscopic videos being analyzed, the technical solutions described herein can be applied to analyze video and image data captured by cameras that are not endoscopic (i.e., cameras external to the patient's body) when performing open surgeries (i.e., not laparoscopic surgeries). For example, the video and image data can be captured by cameras that are mounted on one or more personnel in the operating room (e.g., surgeon). Alternatively, or in addition, the cameras can be mounted on surgical instruments, walls, or other locations in the operating room. Alternatively, or in addition, the video can be images captured by other imaging modalities, such as ultrasound.

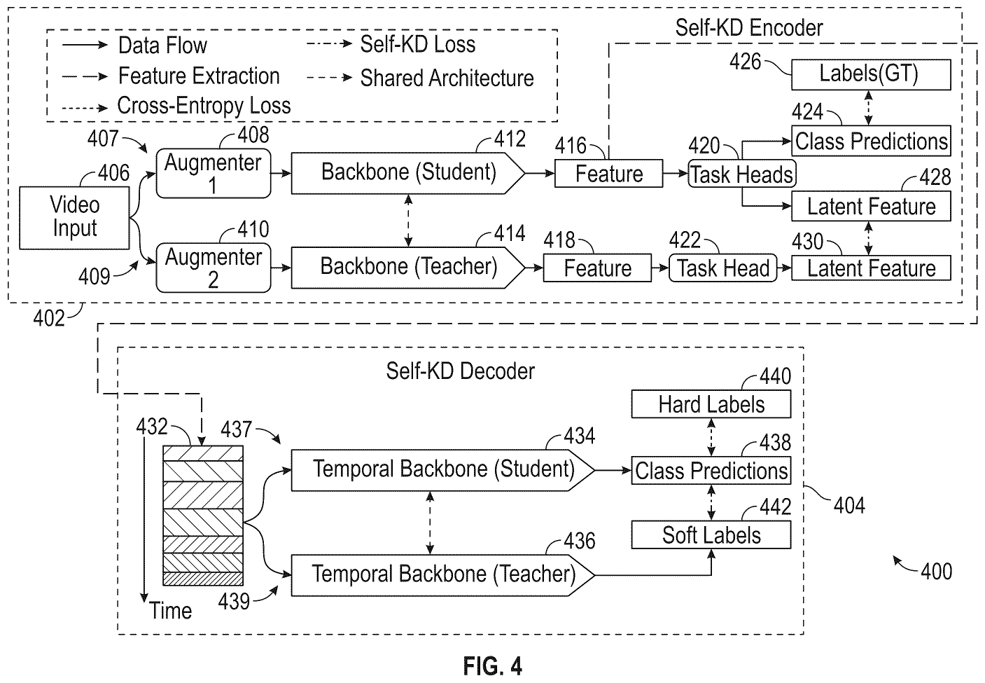

Turning now to FIG. 4, a block diagram of a self-knowledge distillation system 400 is depicted according to one or more aspects. The self-knowledge distillation system 400 includes a self-knowledge distillation encoder 402 and a self-knowledge distillation decoder 404 that can be trained by the machine learning training system 325 of FIG. 3. The machine learning training system 325 can train the self-knowledge distillation encoder 402 using a plurality of video frames of a surgical procedure by joint optimization of a classification loss and feature similarity loss through a student encoder network 407 and a teacher encoder network 409. The video frames can be received as video input 406 from the data store 320 of FIG. 3 during training. The self-knowledge distillation system 400 can apply a different image augmentation to the video frames provided to each of the student encoder network 407 and the teacher encoder network 409. For example, the student encoder network 407 can include a first augmenter 408 and the teacher encoder network 409 can include a second augmenter 410. Examples of augmentation preformed by the first augmenter 408 and the second augmenter 410 can include a horizontal flip, color distortion, blurring, and/or other such adjustment techniques where different augmentation is performed by each of the first augmenter 408 and the second augmenter 410. The student encoder network 407 can include a student backbone portion 412 that generates a plurality of frame representations including features 416. The teacher encoder network 409 can include a teacher backbone portion 414 that generates a plurality of frame representations including features 418. In some aspects, the student backbone portion 412 and the teacher backbone portion 414 can use a same backbone model.

According to an aspect, features 416 extracted by the student encoder network 407 can be provided to the self-knowledge distillation decoder 404. The features 416 can also be provided to a first task-specific head 420 for optimization. The features 418 can be provided to a second task-specific head 422 for optimization. The first task-specific head 420 can perform classification optimization, and the second task-specific head 422 can perform similarity optimization, as an example. The teacher encoder network 409 can generate a feature representation as a target for the student encoder network 407. For example, class predictions 424 (e.g., phase recognition) from the first task-specific head 420 can be compared to ground truth labels 426. Latent features 428 extracted from the first task-specific head 420 can be compared to latent features 430 extracted from the second task-specific head 422 for feature similarity comparison.

The features 416 can be placed in a temporal queue 432 of the self-knowledge distillation decoder 404. A student decoder network 437 and a teacher decoder network 439 can extract the features 416 temporarily stored in the temporal queue 432. The student decoder network 437 can include a student temporal backbone 434, and the teacher decoder network 439 can include a teacher temporal backbone 436. The student temporal backbone 434 of the student decoder network 437 can generate class predictions 438 (e.g., surgical phase predictions) which may be compared against hard labels 440. The teacher temporal backbone 436 of the teacher decoder network 439 can generate soft labels 442 to compare against the class predictions 438.

Further, with a teacher-student configuration, implicit knowledge can be distilled from a teacher to a student module. Aspects of the technical solutions herein enable the encoder to extract enhanced spatial features and reduce over-segmentation at the decoder.

The architecture of the technical solutions herein using self-knowledge distillation framework of FIG. 4 for surgical phase recognition is described further. The self-KD framework includes at least two substructures: 1) a self-KD encoder to extract representative features, and 2) a self-KD decoder integrated into existing backbones for reliable phase recognition. In general, two backbone models can be used, where a teacher network guides the student model. Both networks can share the same structure, allowing the teacher to update the weights from the student, rather than optimizing them through back propagation.

Aspects of the technical solutions described herein provide a self-KD framework to train encoders towards better feature representation learning. Given an augmented view x_{i,1} of an image i, a student model generates two outputs: phase probabilities ŷ_{i,1} and a feature latent representation z̅_{i,1}. An auxiliary teacher model generates a second feature representation z̅_{i,2} from the same image under a different augmentation x_{i,2}. The student network is optimized by training two objectives simultaneously. First, a phase classification task is optimized using output ŷ_{i,1} in a supervised manner. The performance of the student over this objective is measured with Categorical cross-entropy loss [symbol] _{ce}. At the same time a feature distance minimization objective is optimized. Latent representations obtained from student and teacher models can be used. To assess their similarity, a mean-square error [symbol] ₘₛₑ can be used. Further, the two losses can be combined to optimize the student model over a batch of n images.

$$ℒ = {ℒ}_{ce} + {ℒ}_{mse} = {\sum }_{i = 0}^{n} - log ( {\hat{y}}_{i} ) + {\sum }_{i = 0}^{n} {‖ {\overline{z}}_{i , 1} - {\overline{z}}_{i , 2} ‖}_{2}^{2} \qquad ( 1 )$$

As for the teacher model, it is not trained within this framework. Rather, its weights can be updated through Exponential Moving Average (EMA), using student's parameters. This means that its weights are a slow version of student's weights.

Phase recognition decoders incorporate temporal dependencies to generate frame-wise prediction over a video. The self-KD phase decoder provided by aspects of the technical solutions described herein can achieve more reliable predictions based on existing methods without adding network complexity. For a temporal backbone model, its past predictions are used as an additional self-supervision signal (i.e. teacher model). The model is progressively regularized by minimizing the logits distance between student (current predictions) and teacher model.

For an input feature sequence xϵX with length L: x_{1:L} (x₁, x₂, . . . , L) aspects herein assign a class label cϵC to each frame: c_{1:L}=(c₁, c₂, . . . , c_{L}). A temporal backbone model produces the logit vectors and then, using a softmax function, calculates the predicted probabilities as P(x)=[pₗ(x), . . . , p_{L}(x)]. Both student P^{S}(x) and teacher P^{T}(x) probabilities are scaled by a temperature factor for better distillation, in some aspects.

State-of-the-art techniques define a Kullback-Leibler divergence as the distillation loss. Instead, aspects of the technical solutions herein use the truncated mean squared error (MSE) over the frame-wise student and teacher log probabilities as the distillation loss.

$${ℒ}_{T - MSE} = \frac{1}{LC} {\sum }_{l , c} {\tilde{Δ}}_{l , c}^{2} \qquad ( 2 )$$

$${\tilde{Δ}}_{l , c} = \{ \begin{matrix}{Δ}_{l , c} & : {Δ}_{l , c} \leq τ \\ τ & : otherwise\end{matrix} \qquad ( 3 )$$

The value of r can be a truncated threshold, which can be set, for example, to 8. In one or more aspects, the teacher model is defined as the best student model from the training history, which indicates that the teacher model dynamically evolves itself as the training proceeds. Let Pₜ^{s}(x) be the predictions from the student model at t-th epoch, MSE loss Δ_{l,c} can be defined as:

$${Δ}_{l , c} = \vert log {p}_{t}^{S} ( {x}_{l , c} ; τ ) - log {p}_{i < t}^{S} ( {x}_{l - 1 , c} ; τ ) \vert \qquad ( 4 )$$

where i is the preceding epochs with the highest accuracy. It should be noted that gradients are calculated for student predictions p^{S}(x_{l,c}), while teacher predictions p^{T}(x_{l-1,c}) are not considered as model parameters. The threshold r can be set to a predetermined value, e.g., 8.0. Combining with a cross-entropy loss LCE, the final self-KD loss is defined as:

$${ℒ}_{self - KD} = {ℒ}_{CE} + {λℒ}_{T - MSE} \qquad ( 5 )$$

where λ is a model hyper-parameter to determine the contribution of LT-MSE loss.

Table 1 presents the performance results of an example framework compared with state-of-the-art frameworks. According to an aspect, one model (self-KD GRU) achieved competitive results compared to multi-task recurrent convolutional network with correlation loss (MTRCNet-CL) and TeCNO despite the fact that both of these models are multi-task and benefit from additional instrument signals, which are not always available. Both of the self-KD GRU model and self-KD temporal convolutional network (TCN) model surpassed, despite relying on a 2D encoder instead of a more complex 3D Swin-Transformer encoder. Trans-SVNet re-implemented TeCNO to only rely on phase signals. Both Trans-SVNet and TeCNO were assessed without weighting based on class imbalance, which are indicated by star in Table 1. The self-KD TeCNO and self-KD Trans-SVNet exceeded their corresponding baselines. In addition, the model self-KD GRU model reached the new SOTA results for surgical phase recognition task. It outperformed the 3D encoder based Swin+GRU by +2.35% accuracy, +2.39% precision, and +1.28% recall.

TABLE 1
Performance comparison against SOTA approaches, results
are shown in percentage. TeCNO and Trans-SVNet models were
evaluated without taking class imbalance into account.

| | Acc. | Pre. | Recall | F1-score | Jaccard |
|---|---|---|---|---|---|
| MTRCNet-CL | 89.2 | 86.9 | 88.0 | — | — |
| TeCNO | 88.56 | 81.64 | 85.24 | — | — |
| Swin + GRU | 90.88 | 85.07 | 85.59 | — | — |
| TeCNO from | 88.6 | 86.5 | 87.6 | — | 75.1 |
| Trans-SVNet | 90.3 | 90.7 | 88.8 | — | 79.3 |
| TeCNO* | 90.20 | 84.12 | 85.34 | 82.65 | 74.07 |
| Trans-SVNet* | 89.85 | 84.96 | 84.48 | 82.25 | 74.01 |
| Self-KD TeCNO | 91.37 | 86.41 | 84.09 | 84.09 | 76.04 |
| Self-KD Trans-SVNet | 91.68 | 86.12 | 86.06 | 84.42 | 76.56 |
| Self-KD TCN | 91.78 | 85.88 | 87.39 | 85.08 | 77.67 |
| Self-KD GRU | 93.24 | 87.46 | 86.87 | 85.61 | 78.56 |

To further investigate the efficiency of each sub-component in the framework described herein, ablative studies with four SOTA models have been examined as a further example: (1) baseline encoder+baseline decoder; (2) encoder self-KD+baseline decoder; (3) baseline encoder+decoder self-KD; (4) encoder self-KD+decoder self-KD. The results are presented in Table 2, from which it can be observed that for: (1) vs. (2) and (1) vs. (3): These experiments show the impact of applying self-KD at different stages. Applying self-KD to each stage alone can improve the results. In general, adding self-KD to an encoder results in higher boost in overall performance. This highlights the importance of self-KD in building more robust features. For (2) vs. (4) and (3) vs. (4): In general, the model performance benefits from two-stage self-KD (both encoder and decoder stage), especially the accuracy.

For other evaluation metrics, two-stage self-KD TCN and self-KD GRU still outperform the single-stage model. Encoder self-KD can contribute more to TeCNO and Trans-SVNet in recall, F1-score, and Jaccard. The learning ability of self-KD relies on the solution space of the model itself. TeCNO and Trans-SVNet (TeCNO based) present a small temporal convolutional based model (117K parameters) compared with reported TCN (297K parameters parameters) or GRU (481K parameters). In this regard, the temporal model may have limited capacity to distillate the knowledge. For (1) vs. (4): Self-KD can be combined with various backbone models and it can consistently improve the results over baseline models. This highlights the effectiveness of self-KD in building more robust models. Specifically, a best performing model, self-KD GRU, not only exceeds the performance of other three models, but can boost performance over its own baseline by +5.32% Jaccard.

TABLE 2
Results of adding self-KD into training of architecture stages progressively, shown in percentage, for a Cholec80
test set (e.g., an endoscopic video dataset containing 80 videos of cholecystectomy surgeries performed by
13 surgeons). Metrics are obtained first per video and then average and standard deviation are reported.
TeCNO and Trans-SVNet baselines results are obtained using an implementation for fair comparison.

| | self- | self- | | | | | |
|---|---|---|---|---|---|---|---|
| | KD-Enc | KD-Dec | Acc | Pre | Rec | F1-score | JA |
| TCN | | | 89.95 ± 6.10 | 84.43 ± 8.54 | 83.48 ± 7.70 | 81.26 ± 9.09 | 72.66 ± 11.01 |
| | ✓ | | 91.20 ± 5.39 | 85.85 ± 7.45 | 86.71 ± 7.14 | 84.50 ± 7.64 | 76.87 ± 9.28 |
| | | ✓ | 90.54 ± 5.73 | 85.39 ± 7.97 | 84.75 ± 7.22 | 82.75 ± 8.57 | 74.58 ± 10.03 |
| | ✓ | ✓ | 91.78 ± 5.20 | 85.88 ± 7.86 | 87.39 ± 6.7.16 | 85.08 ± 7.95 | 77.67 ± 9.69 |
| TeCNO | | | 90.20 ± 5.76 | 84.12 ± 8.89 | 85.34 ± 7.18 | 82.65 ± 8.76 | 74.07 ± 10.85 |
| | ✓ | | 90.78 ± 6.32 | 84.85 ± 8.34 | 87.27 ± 7.11 | 84.24 ± 8.21 | 76.53 ± 10.28 |
| | | ✓ | 90.32 ± 5.95 | 84.24 ± 8.76 | 85.17 ± 6.96 | 82.63 ± 8.66 | 74.03 ± 10.72 |
| | ✓ | ✓ | 91.37 ± 5.09 | 86.41 ± 7.67 | 85.63.35 ± 7.59 | 84.09 ± 8.01 | 76.04 ± 10.05 |
| Trans- | | | 89.85 ± 6.02 | 84.96 ± 8.21 | 84.48 ± 7.77 | 82.25 ± 9.02 | 74.01 ± 10.83 |
| SVNet | ✓ | | 91.33 ± 5.97 | 85.22 ± 7.83 | 87.29 ± 6.38 | 84.66 ± 7.43 | 77.09 ± 8.99 |
| | | ✓ | 90.81 ± 5.59 | 86.93 ± 7.59 | 85.97 ± 6.65 | 84.34 ± 8.06 | 76.32 ± 10.00 |
| | ✓ | ✓ | 91.68 ± 4.79 | 86.12 ± 7.28 | 86.06 ± 6.94 | 84.42 ± 7.27 | 76.56 ± 8.74 |
| GRU | | | 89.91 ± 7.42 | 83.10 ± 9.45 | 84.06 ± 8.92 | 81.66 ± 10.02 | 73.24 ± 12.06 |
| | ✓ | | 92.73 ± 5.34 | 86.04 ± 7.47 | 86.80 ± 7.77 | 84.75 ± 7.75 | 77.65 ± 9.45 |
| | | ✓ | 91.05 ± 5.54 | 85.28 ± 8.88 | 82.85 ± 7.00 | 82.13 ± 8.05 | 73.53 ± 10.03 |
| | ✓ | ✓ | 93.24 ± 4.36 | 87.46 ± 7.44 | 86.87 ± 7.46 | 85.61 ± 7.37 | 78.56 ± 9.04 |

According to aspects, experiments can assess the effect of reducing training data sizes. Videos can be randomly removed from a training set and compared with baselines trained on the full set. Videos can be removed from the training set in two ways: excluding the video from the training altogether or excluding phase ground truth labels, in other words, only self-KD loss is applied over those videos. The ResNet50+GRU model was used for the experiment reported in Table 3. These experiments are referred to as: (1) models trained on full dataset; (2) baseline model trained on reduced sets of training videos; (3) self-KD GRU trained on reduced sets of training videos; (4) self-KD GRU trained on reduced sets of training videos in classification loss. For (1) vs. (2) vs.(3): In general reducing the size of the training set has degraded performance for all models. The self-KD model trained on 87.5% of the data or even when it is trained on 75% of the data outperformed the baseline model trained on the full dataset. This finding may be important for a surgical phase recognition task, as generating annotations for surgical videos can be time consuming and more expensive than in general domain computer vision dataset. For (1) vs. (4) and (3) vs.(4): Less reduction in performance in (4) compared with (3), highlights the ability of the proposed framework in learning from unlabeled videos. Reducing the size of the training set by 50% can result in self-KD achieving performance on par with the same model trained on full training sets. This show the impact of using training data more effectively to generate more reliable models and reducing a need for generating huge labeled phase datasets.

TABLE 3
Effect of reducing the number of training videos. Results are shown
in percentage for Cholec80 test set with 40 training videos.

| Encoder | # videos excluded | excluded from | Accuracy | F1-score | Jaccard |
|---|---|---|---|---|---|
| ResNet50 | 0 | | 89.91 ± 7.42 | 81.66 ± 10.02 | 72.66 ± 12.06 |
| self-KD-ResNet50 | 0 | | 93.24 ± 4.36 | 85.61 ± 7.37 | 78.56 ± 9.04 |
| ResNet50 | 5 | training | 87.98 ± 9.59 | 78.74 ± 1.57 | 69.82 ± 12.40 |
| | 10 | | 87.32 ± 8.23 | 79.13 ± 8.68 | 69.60 ± 10.59 |
| | 20 | | 84.31 ± 11.35 | 74.39 ± 9.42 | 63.86 ± 10.79 |
| self-KD-ResNet50 | 5 | training | 92.38 ± 4.32 | 85.82 ± 8.47 | 76.33 ± 9.80 |
| | 10 | | 89.45 ± 6.78 | 84.42 ± 8.48 | 72.78 ± 9.95 |
| | 20 | | 88.22 ± 8.95 | 79.76 ± 9.16 | 71.33 ± 10.63 |
| self-KD-ResNet50 | 5 | classification loss | 92.44 ± 4.82 | 83.39 ± 8.11 | 76.20 ± 9.31 |
| | 10 | | 89.99 ± 9.10 | 82.54 ± 8.48 | 74.26 ± 10.67 |
| | 20 | | 89.69 ± 7.68 | 81.99 ± 9.07 | 74.74 ± 10.62 |

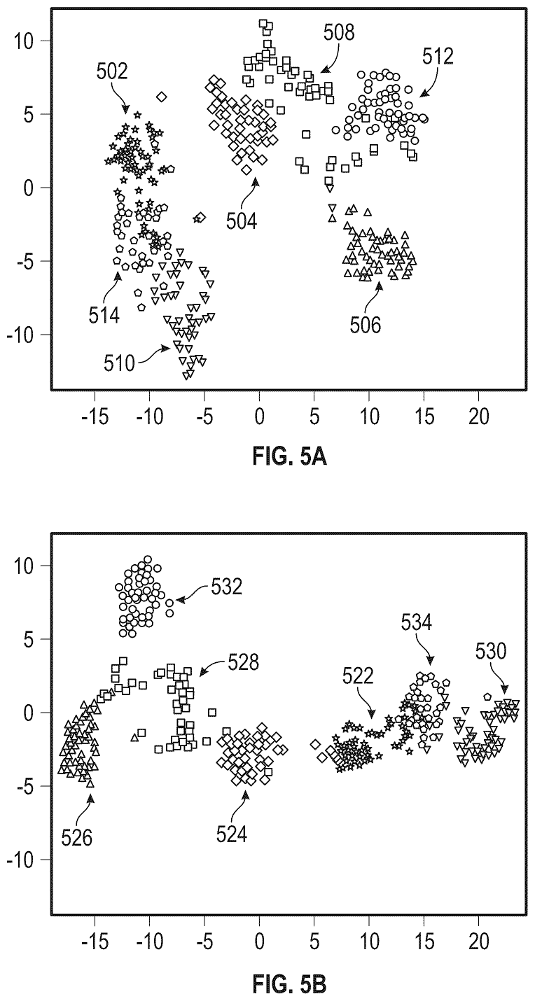

FIG. 5A depicts a scatter plot of video frame features according to one approach, where ResNet50 was used as a baseline for surgical phase recognition. FIG. 5B depicts a scatter plot of video frame features according to one or more aspects, where self-knowledge distillation training of ResNet50 was used for surgical phase recognition. Surgical phase recognition results in FIG. 5A include preparation 502, Calot Triangle dissection 504, clipping cutting 506, gallbladder dissection 508, gallbladder packaging 510, cleaning coagulation 512, and gallbladder retraction 514. Similarly, surgical phase recognition results in FIG. 5B include preparation 522, Calot Triangle dissection 524, clipping cutting 526, gallbladder dissection 528, gallbladder packaging 530, cleaning coagulation 532, and gallbladder retraction 534. Comparing the results for surgical phases, such as Calot Triangle dissection 504 to Calot Triangle dissection 524 and gallbladder packaging 510 to gallbladder packaging 530, it can be seen that denser and more separable representations can be achieved when self-knowledge distillation is used, which facilitates more accurate phase detection.

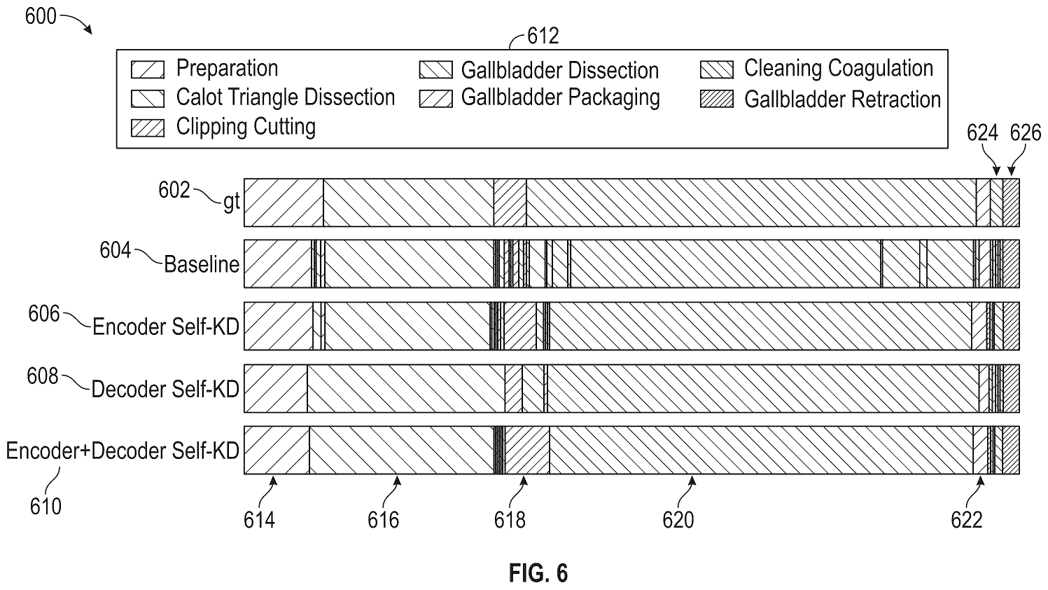

FIG. 6 depicts a plot of prediction results 600 according to one or more aspects. The example of FIG. 6 illustrates a qualitative comparison of a self-KD GRU model (e.g., a GRU model trained using the self-KD approach of FIG. 4). A ground truth plot 602 is illustrated for comparison. It can be observed that a GRU baseline model 604 misclassified more frames than self-KD models 606, 608, 610 and suffers from severe over-segmentation issues, which can result in mixing phases (e.g., see legend 612), such as preparation 614 and Calot Triangle dissection 616 as well as misclassification of clipping cutting 618 and gallbladder dissection 620. The GRU baseline model 604 also has more misclassifying of gallbladder packaging 622 with cleaning coagulation 624 but did well in classifying gallbladder retraction 626. Adding only the encoder self-KD in model 606 generates more accurate predictions but over-segments some frames around clipping and cutting 618. Due to the limited feature representative ability of baseline ResNet, a self-KD decoder model 608 has smoother predictions but still some noisy prediction towards the end of the video. Combining the encoder and decoder self-KD in model 610, more reliable and smoother predictions can be observed. Both quantitative and qualitative results show the superior performance of the self-KD approach and the potential advantages of encoder and decoder self-KD training in building robust models.

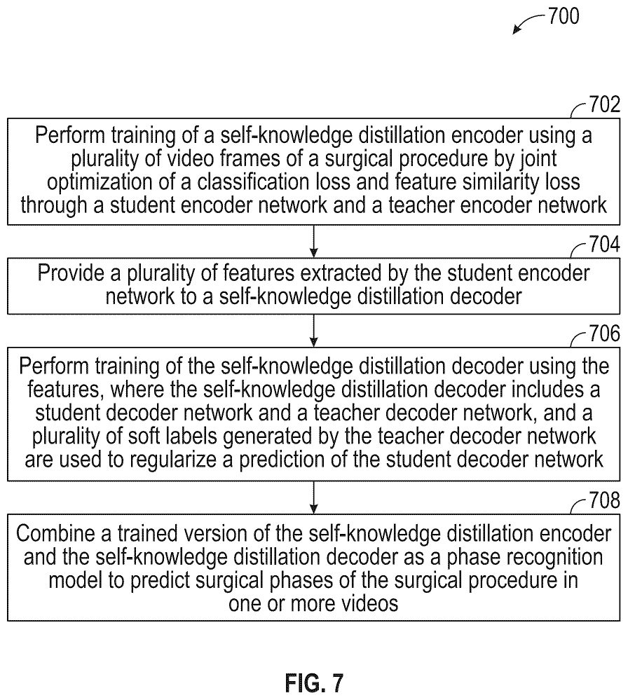

Turning now to FIG. 7, a flowchart of a method 700 for self-knowledge distillation for surgical phase recognition is generally shown in accordance with one or more aspects. All or a portion of method 700 can be implemented, for example, by all or a portion of CAS system 100 of FIG. 1 and/or computer system 800 of FIG. 8. Further, the machine learning training system 325 of FIG. 3 can be used to train the self-knowledge distillation encoder 402 and the self-knowledge distillation decoder 404 of FIG. 4.

At block 702, training of a self-knowledge distillation encoder 402 can be performed using a plurality of video frames of a surgical procedure of video input 406 by joint optimization of a classification loss and feature similarity loss through a student encoder network 407 and a teacher encoder network 409. At block 704, a plurality of features 416 extracted by the student encoder network 407 is provided to a self-knowledge distillation decoder 404. At block 706, training of the self-knowledge distillation decoder 404 is performed using the features 416, where the self-knowledge distillation decoder 404 includes a student decoder network 437 and a teacher decoder network 439, and a plurality of soft labels 442 generated by the teacher decoder network 439 is used to regularize a prediction of the student decoder network 437. At block 708, a trained version of the self-knowledge distillation encoder 402 and the self-knowledge distillation decoder 404 are combined as a phase recognition model to predict surgical phases of the surgical procedure in one or more videos. The phase recognition model can be one of the trained models stored in the trained machine learning models 330 of FIG. 3.

According to some aspects, the method 700 can include applying a different image augmentation to the video frames provided to each of the student encoder network 407 and the teacher encoder network 409. The method 700 can also include where the student encoder network 407 includes a student backbone portion 412 that generates a plurality of frame representations. The method 700 may include forwarding the frame representations to a first task-specific head 420 to perform classification optimization and a second task-specific head 422 to perform similarity optimization. The method 700 can include where the teacher encoder network generates a feature representation as a target for the student encoder network 407. The student encoder network 407 can be trained for phase recognition and feature similarity. The soft labels 442 can be generated by the teacher decoder network 439 in a current epoch are used to produce predictions for a same video frame as the student decoder network 437 with variant logits. The method 700 can include minimizing teacher and student logits using a smoothing loss.

The processing shown in FIG. 7 is not intended to indicate that the operations are to be executed in any particular order or that all of the operations shown in FIG. 7 are to be included in every case. Additionally, the processing shown in FIG. 7 can include any suitable number of additional operations.

Technical effects include a self-knowledge distillation framework for surgical phase recognition. Rather than increasing model complexity, self-KD can be embedded into existing models to utilize training data more effectively. Implicit knowledge can be distilled in a single training process such that the encoder generates informative representations and the over-segmentation errors are reduced on the temporal decoder stage. As one example, the framework can be assessed by applying it to other known surgical phase recognition models. It has been seen that the framework can outperform baselines over evaluation metrics and at least one model, self-KD GRU, may achieve new SOTA performance. Accordingly, the potential of the self-knowledge distillation framework can be seen in efficiently utilizing training data for building more robust models.

Turning now to FIG. 8, a computer system 800 is generally shown in accordance with an aspect. The computer system 800 can be an electronic computer framework comprising and/or employing any number and combination of computing devices and networks utilizing various communication technologies, as described herein. The computer system 800 can be easily scalable, extensible, and modular, with the ability to change to different services or reconfigure some features independently of others. The computer system 800 may be, for example, a server, desktop computer, laptop computer, tablet computer, or smartphone. In some examples, computer system 800 may be a cloud computing node. Computer system 800 may be described in the general context of computer-executable instructions, such as program modules, being executed by a computer system. Generally, program modules may include routines, programs, objects, components, logic, data structures, and so on that perform particular tasks or implement particular abstract data types. Computer system 800 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 8, the computer system 800 has one or more central processing units (CPU(s)) 801a, 801b, 801c, etc. (collectively or generically referred to as processor(s) 801). The processors 801 can be a single-core processor, multi-core processor, computing cluster, or any number of other configurations. The processors 801 can be any type of circuitry capable of executing instructions. The processors 801, also referred to as processing circuits, are coupled via a system bus 802 to a system memory 803 and various other components. The system memory 803 can include one or more memory devices, such as read-only memory (ROM) 804 and a random-access memory (RAM) 805. The ROM 804 is coupled to the system bus 802 and may include a basic input/output system (BIOS), which controls certain basic functions of the computer system 800. The RAM is read-write memory coupled to the system bus 802 for use by the processors 801. The system memory 803 provides temporary memory space for operations of said instructions during operation. The system memory 803 can include random access memory (RAM), read-only memory, flash memory, or any other suitable memory systems.

The computer system 800 comprises an input/output (I/O) adapter 806 and a communications adapter 807 coupled to the system bus 802. The I/O adapter 806 may be a small computer system interface (SCSI) adapter that communicates with a hard disk 808 and/or any other similar component. The I/O adapter 806 and the hard disk 808 are collectively referred to herein as a mass storage 810.

Software 811 for execution on the computer system 800 may be stored in the mass storage 810. The mass storage 810 is an example of a tangible storage medium readable by the processors 801, where the software 811 is stored as instructions for execution by the processors 801 to cause the computer system 800 to operate, such as is described hereinbelow with respect to the various Figures. Examples of computer program product and the execution of such instruction is discussed herein in more detail. The communications adapter 807 interconnects the system bus 802 with a network 812, which may be an outside network, enabling the computer system 800 to communicate with other such systems. In one aspect, a portion of the system memory 803 and the mass storage 810 collectively store an operating system, which may be any appropriate operating system to coordinate the functions of the various components shown in FIG. 8.

Additional input/output devices are shown as connected to the system bus 802 via a display adapter 815 and an interface adapter 816 and. In one aspect, the adapters 806, 807, 815, and 816 may be connected to one or more I/O buses that are connected to the system bus 802 via an intermediate bus bridge (not shown). A display 819 (e.g., a screen or a display monitor) is connected to the system bus 802 by a display adapter 815, which may include a graphics controller to improve the performance of graphics-intensive applications and a video controller. A keyboard, a mouse, a touchscreen, one or more buttons, a speaker, etc., can be interconnected to the system bus 802 via the interface adapter 816, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 800 includes processing capability in the form of the processors 801, and storage capability including the system memory 803 and the mass storage 810, input means such as the buttons, touchscreen, and output capability including the speaker 823 and the display 819.

In some aspects, the communications adapter 807 can transmit data using any suitable interface or protocol, such as the internet small computer system interface, among others. The network 812 may be a cellular network, a radio network, a wide area network (WAN), a local area network (LAN), or the Internet, among others. An external computing device may connect to the computer system 800 through the network 812. In some examples, an external computing device may be an external web server or a cloud computing node.

It is to be understood that the block diagram of FIG. 8 is not intended to indicate that the computer system 800 is to include all of the components shown in FIG. 8. Rather, the computer system 800 can include any appropriate fewer or additional components not illustrated in FIG. 8 (e.g., additional memory components, embedded controllers, modules, additional network interfaces, etc.). Further, the aspects described herein with respect to computer system 800 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects. Various aspects can be combined to include two or more of the aspects described herein.

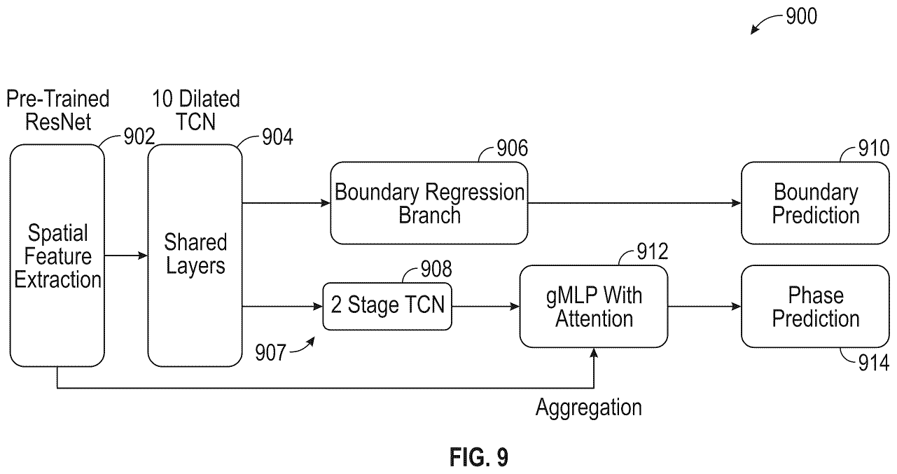

FIG. 9 depicts a block diagram of a boundary aware hybrid embedding network 900 according to one or more aspects. A surgical video can be input, such as from video recording system 104 of FIG. 1, from which latent image features are obtained using a pre-trained encoder 902, such as a ResNet or SENet (e.g., SENet154). In some aspects, the pre-trained encoder 902 can be a trained version of the self-knowledge distillation encoder 402 of FIG. 4. A representation of an entire video can be fed into the boundary aware hybrid embedding network 900. Phase prediction is divided into two branches including a boundary regression branch 906 and a frame-wise phase classification branch 907. Spatial feature extraction can be performed by the pre-trained encoder 902 to extract latent image features as the features representing the video. The features can pass through a temporal convolutional network 904 to perform at least partial video-based action segmentation prior to providing the features to the boundary regression branch 906 and the frame-wise phase classification branch 907. In some aspects, the temporal convolutional network 904 can include multiple layers (e.g., 4, 6, 8, 10, 12, 14, 16, etc.) as shared layers with at least one dilated convolution layer, where the temporal convolutional network 904 can be a shared head for the boundary regression branch 906 and the frame-wise phase classification branch 907. For the frame-wise phase classification branch 907, a dilated one-dimensional convolution can be utilized (e.g., using a two-stage temporal convolutional network 908) to extract temporal features such that the receptive field can be enlarged exponentially. A gated-multilayer perceptron (gMLP) 912 can be applied to query the temporal features using the features extracted by the spatial feature extraction of the pre-trained encoder 902. Spatial embedding can be reused to query temporal embeddings with the gMLP 912, which can be much lighter (e.g., reduced computational burden) than a transformer attention architecture, for example. The boundary regression branch 906 can predict the action boundaries and apply a majority voting strategy to refine the prediction from a frame-wise phase classification of the frame-wise phase classification branch 907. This facilitates having the same temporal convolution structure as frame-wise classification but with fewer layers. A final prediction can be generated by aggregating outputs of the boundary regression branch 906 as a boundary prediction 910 and the frame-wise phase classification branch 907 as a phase prediction 914. In addition, using a large margin Gaussian mixture loss to model feature distribution can improve the robustness of the boundary aware hybrid embedding network 900. The use of a Gaussian mixture loss to model feature distribution differs from other model that may use softmax cross-entropy.

Performance of the aspects of the technical solutions described herein on an internal partial nephrectomy dataset can outperform a state-of-the-art non-causal temporal convolutional network (NCTCN) baseline by +2 points in accuracy and +4 points in F1 score, for example.

Accordingly, the technical solutions described herein facilitate building robust phase-detection models. The technical solutions described herein improve technical fields, such as computing technology, surgical video analysis, computer-assisted surgical systems, etc. In addition, the technical solutions described herein provide practical applications in context-aware surgical assistance system as it contributes to resource scheduling, surgery monitoring, decision support, etc. It is understood that the technical solutions herein provide several additional improvements and practical applications.

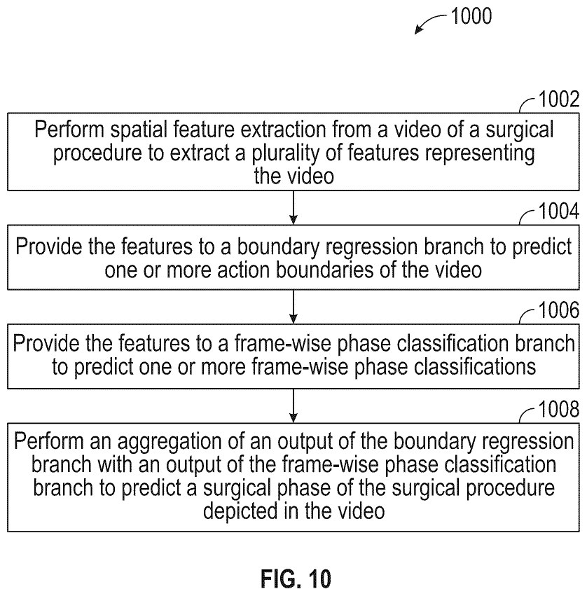

FIG. 10 depicts a flowchart of a method 1000 of surgical phase recognition using a boundary aware hybrid embedding network 900 of FIG. 9 according to one or more aspects. All or a portion of method 1000 can be implemented, for example, by all or a portion of CAS system 100 of FIG. 1, surgical procedure support system 202 of FIG. 2, and/or computer system 800 of FIG. 8. Further, the machine learning execution system 340 of FIG. 3 can perform at least a portion of the method 1000.

At block 1002, spatial feature extraction from a video of a surgical procedure can be performed to extract a plurality of features representing the video. At block 1004, the features can be provided to a boundary regression branch 906 to predict one or more action boundaries of the video. At block 1006, the features can be provided to a frame-wise phase classification branch 907 to predict one or more frame-wise phase classifications. At block 1008, an aggregation can be performed of an output (e.g., boundary prediction 910) of the boundary regression branch 906 with an output (e.g., phase prediction 914) of the frame-wise phase classification branch 907 to predict a surgical phase of the surgical procedure depicted in the video.

In some aspects, spatial feature extraction can be performed by a pre-trained encoder 902 to extract latent image features as the features representing the video. In some aspects, the features pass through a temporal convolutional network 904 to perform at least partial video-based action segmentation prior to providing the features to the boundary regression branch 906 and the frame-wise phase classification branch 907. The boundary regression branch 906 can perform majority voting to refine a prediction from the frame-wise phase classification branch 907. The frame-wise phase classification branch 907 can apply a dilated convolution (e.g., using a two-stage temporal convolutional network 908) to extract temporal features to enlarge a receptive field. In some aspects, a gated-multilayer perceptron 912 can be applied to query the temporal features using the features extracted by the spatial feature extraction. Further, a Gaussian mixture loss can be used to model feature distribution.

The processing shown in FIG. 10 is not intended to indicate that the operations are to be executed in any particular order or that all of the operations shown in FIG. 10 are to be included in every case. Additionally, the processing shown in FIG. 10 can include any suitable number of additional operations.

Aspects disclosed herein may be a system, a method, and/or a computer program product at any possible technical detail level of integration. The computer program product may include a computer-readable storage medium (or media) having computer-readable program instructions thereon for causing a processor to carry out various aspects.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language, such as Smalltalk, C++, high-level languages such as Python, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present disclosure.

Aspects are described herein with reference to flowchart illustrations and/or block diagrams of methods, apparatus (systems), and computer program products according to aspects of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer system, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects are described herein with reference to the related drawings. Alternative aspects can be devised without departing from the scope of this disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium, such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), graphics processing units (GPUs), microprocessors, application-specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

1. A computer-implemented method comprising:
performing training of a self-knowledge distillation encoder using a plurality of video frames of a surgical procedure by joint optimization of a classification loss and feature similarity loss through a student encoder network and a teacher encoder network;
providing a plurality of features extracted by the student encoder network to a self-knowledge distillation decoder;
performing training of the self-knowledge distillation decoder using the features, wherein the self-knowledge distillation decoder comprises a student decoder network and a teacher decoder network, and a plurality of soft labels generated by the teacher decoder network are used to regularize a prediction of the student decoder network; and
combining a trained version of the self-knowledge distillation encoder and the self-knowledge distillation decoder as a phase recognition model to predict surgical phases of the surgical procedure in one or more videos.

2. The computer-implemented method of claim 1, further comprising applying a different image augmentation to the video frames provided to each of the student encoder network and the teacher encoder network.

3. The computer-implemented method of claim 1, wherein the student encoder network comprises a student backbone portion that generates a plurality of frame representations.

4. The computer-implemented method of claim 3, further comprising forwarding the frame representations to a first task-specific head to perform classification optimization and a second task-specific head to perform similarity optimization.

5. The computer-implemented method of claim 4, wherein the teacher encoder network generates a feature representation as a target for the student encoder network.

6. The computer-implemented method of claim 1, wherein the student encoder network is trained for phase recognition and feature similarity.

7. The computer-implemented method of claim 1, wherein the soft labels generated by the teacher decoder network in a current epoch are used to produce predictions for a same video frame as the student decoder network with variant logits.

8. The computer-implemented method of claim 7, further comprising minimizing teacher and student logits using a smoothing loss.

9. A system comprising:
a data store comprising video data associated with a surgical procedure; and
a machine learning training system configured to:
train a self-knowledge distillation encoder using a plurality of video frames of the video data by joint optimization of a classification loss and feature similarity loss through a student encoder network and a teacher encoder network;
train a self-knowledge distillation decoder using a plurality of features extracted by the student encoder network, wherein the self-knowledge distillation decoder comprises a student decoder network and a teacher decoder network; and
store a trained version of the self-knowledge distillation encoder and the self-knowledge distillation decoder as a phase recognition model.

10. The system of claim 9, wherein the machine learning training system is configured to use a plurality of soft labels generated by the teacher decoder network to regularize a prediction of the student decoder network.

11. The system of claim 10, wherein the machine learning training system is configured to produce predictions for a same video frame as the student decoder network with variant logits based on the soft labels generated by the teacher decoder network in a current epoch.

12. The system of claim 9, wherein the machine learning training system is configured to apply a different image augmentation to the video frames provided to each of the student encoder network and the teacher encoder network.

13. The system of claim 9, wherein the machine learning training system is configured to forward a plurality of frame representations to a first task-specific head to perform classification optimization and a second task-specific head to perform similarity optimization, wherein the student encoder network comprises a student backbone portion that generates a plurality of frame representations, and the teacher encoder network generates a feature representation as a target for the student encoder network.

14. A computer-implemented method comprising:
performing spatial feature extraction from a video of a surgical procedure to extract a plurality of features representing the video;
providing the features to a boundary regression branch to predict one or more action boundaries of the video;
providing the features to a frame-wise phase classification branch to predict one or more frame-wise phase classifications; and
performing an aggregation of an output of the boundary regression branch with an output of the frame-wise phase classification branch to predict a surgical phase of the surgical procedure depicted in the video.

15. The computer-implemented method of claim 14, wherein spatial feature extraction is performed by a pre-trained encoder to extract latent image features as the features representing the video.

16. The computer-implemented method of claim 14, further comprising:
passing the features through a temporal convolutional network to perform at least partial video-based action segmentation prior to providing the features to the boundary regression branch and the frame-wise phase classification branch.

17. The computer-implemented method of claim 16, wherein the boundary regression branch performs majority voting to refine a prediction from the frame-wise phase classification branch.

18. The computer-implemented method of claim 16, wherein the frame-wise phase classification branch applies a dilated convolution to extract temporal features to enlarge a receptive field.

19. The computer-implemented method of claim 18, further comprising:
applying a gated-multilayer perceptron to query the temporal features using the features extracted by the spatial feature extraction.

20. The computer-implemented method of claim 1, further comprising:
using a Gaussian mixture loss to model feature distribution.
